(19) United States
(12) Patent Application Publication
(10) Pub. No.: US 2007/0091553 A1
(43) Pub. Date: Apr. 26, 2007

(54) Overturn structure of a dual-usage computer

(75) Inventor: En-Bair Chang, Taipei City (TW)

Correspondence Address: BACON & THOMAS, PLLC, 625 SLATERS LANE, FOURTH FLOOR, ALEXANDRIA, VA, 22314, US

(73) Assignee: ASUSTEK COMPUTER INC., Taipei City (TW)

(21) Appl. No.: 11/529,340

(22) Filed: Sep. 29, 2006

(30) Foreign Application Priority Data
Oct. 4, 2005 (TW) 094134651

(51) Int. Cl. G06F 1/16

(52) U.S. Cl. 361/681

(57) ABSTRACT

An overturn structure used in a dual-usage computer comprises a display panel and a base member for enabling the display panel and the base member to be rotated relative to each other to change the computer between the notebook computer mode and the tablet PC mode is disclosed to include two first knuckles fixedly provided at a lateral side of the display panel, two second knuckles fixedly provided at a lateral side of the base member, and two coupling devices each having a first pivot respectively pivoted to the knuckles at the display panel and a second pivot respectively pivoted to the knuckles at the base member and a connecting member connected between the first pivot and the second pivot to hold the first pivot and the second pivot in parallel.

### BACKGROUND OF THE INVENTION

1. Field of the Invention

The present invention relates to an overturn structure and more particularly, to an overturn structure used in a dual-usage computer.

2. Description of Related Art

A regular dual-usage computer comprises a base member and a display panel. The base member carries a keyboard. The display panel is pivoted to the base member and rotatable relative to the base member. When the display panel is set with the display screen facing the base member, the dual-usage computer is used as a notebook computer. On the contrary, when rotated the display panel to the position where the display screen is opposite to the base member, the dual-usage computer is used as a tablet PC.

Conventionally, the display panel is pivotally mounted on a hinge at one side of base member. When changing the dual-usage computer between the notebook mode and the tablet PC mode, the user must open the display panel from the base member, and then rotate the display panel through 180°, and then close the display panel on the base member.

The coupling structure between the display panel and the base member of the aforesaid dual-usage computer is complicated. Further, the procedure of changing the aforesaid dual-usage computer between the notebook computer mode and the tablet PC mode is also complicated.

### SUMMARY OF THE INVENTION

The present invention has been accomplished under the circumstances in view. According to the present invention, the overturn structure is used in a dual-usage computer, which comprises a display panel and a base member carrying a keyboard, for enabling the display panel and the base member to be rotated relative to each other and alternatively set between a first mode to have the dual-usage computer be used as a notebook computer and a second mode to have the dual-usage computer be used as a tablet PC. The overturn structure comprises at least one first pivot element respectively fixedly provided at a lateral side of the display panel, at least one second pivot element respectively fixedly provided at a lateral side of the base member corresponding to the at least one first pivot element; and at least one coupling device respectively coupled between the at least one first pivot element and the at least one second pivot element to join the display panel and the base member. The at least one coupling device has a first coupling element pivoted to the at least one first pivot element, a second coupling element pivoted to the at least one second pivot element, and a connecting member connected between one end of the first coupling element and one end of the second coupling element to hold the first coupling element and the second coupling element in parallel.

By means of the overturn structure, the user can rotate the display panel relative to the base member to set the dual-usage computer alternatively between two modes for enabling the dual-usage computer to be used as a notebook computer or a tablet PC.

Further, the first and second pivot elements can be knuckles (pivot holes), and the first and second coupling elements of the coupling devices can be pivot pins respectively pivoted to the knuckles (pivot holes). Alternatively, the first and second pivot elements can be pivot pins and the first and second coupling elements of the coupling devices can be knuckles (pivot holes) respectively coupled to the pivot pins of the first and second pivot elements.

### BRIEF DESCRIPTION OF THE DRAWINGS

FIG. 1 is an elevational view of a dual-usage computer set in the form of a notebook computer according to the present invention.

FIG. 2 is a schematic drawing showing the overturn operation of the present invention.

FIG. 3 is an elevational view showing the dual-usage computer set in the form of a tablet PC according to the present invention.

### DETAILED DESCRIPTION OF THE PREFERRED EMBODIMENT

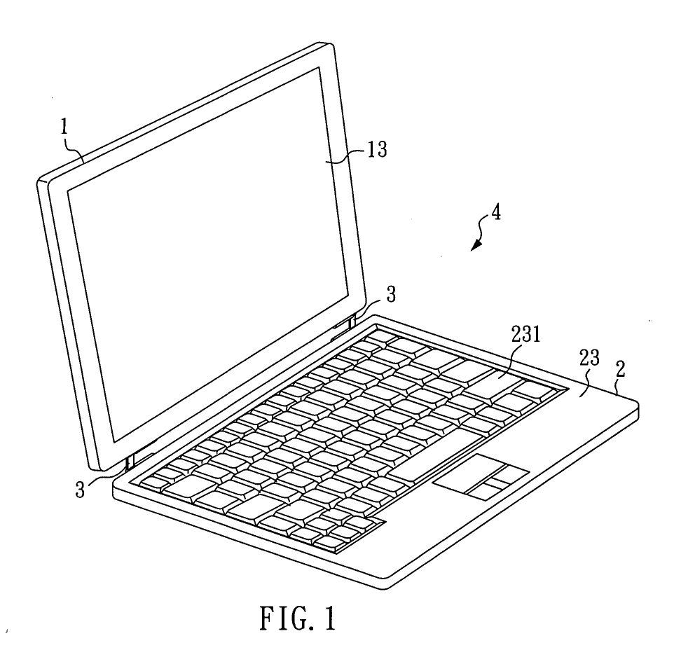

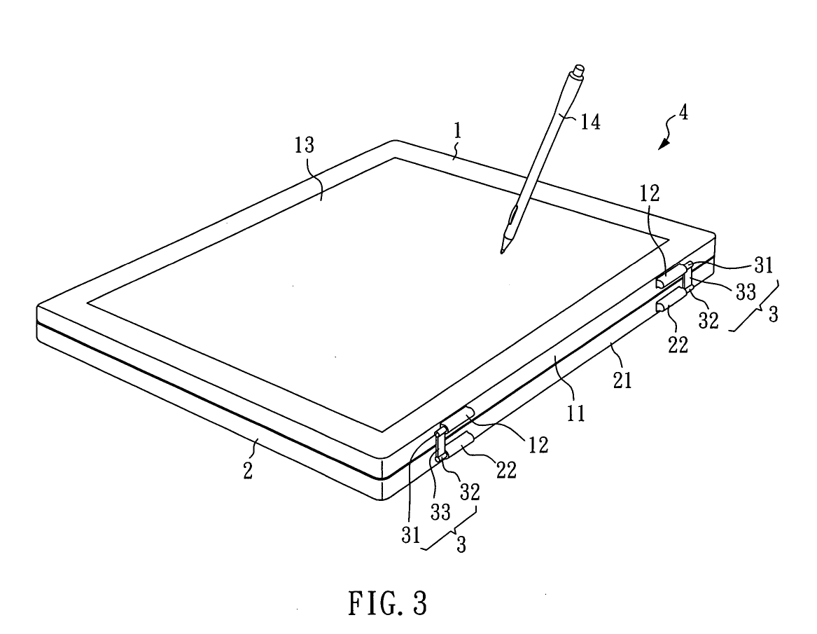

Referring to FIG. 1˜FIG. 3, a dual-usage computer 4 is shown comprising a display panel 1 and a base member 2. According to this embodiment, the display panel 1 is a touch panel display device.

The display panel 1 of the aforesaid dual-usage computer 4 has a lateral side 11, and a display screen 13. The base member 2 of the aforesaid dual-usage computer 4 has a lateral side 21 corresponding to the lateral side 11 of the display panel 1, a top wall 23, and a keyboard 231 mounted on the top wall 23.

The aforesaid dual-usage computer 4 further comprises an overturn structure through which the dual-usage computer 4 can be alternatively set between the notebook mode and the tablet PC mode. This overturn structure comprises two first pivot elements 12, i.e., first knuckles (pivot holes) fixedly provided at the lateral side 11 of the display panel 1, two second pivot elements 22, i.e., second knuckles (pivot holes) fixedly provided at the lateral side 21 of the base member 2 corresponding to the first pivot elements 12 at the display panel 1, and two dual-pivot coupling devices 3 respectively coupled between the first pivot elements 12 and the second pivot elements 22. Each dual-pivot coupling device 3 comprises a first coupling element 31, a second coupling element 32, and a connecting member 33 connected between one end of the first coupling element 31 and one end of the second coupling element 32 to hold the first coupling element 31 and the second coupling element 32 in parallel. According to this embodiment, the first and second coupling elements 31 and 32 are pivot pins respectively coupled to the first pivot elements 12 and the second pivot elements 22.

By means of the aforesaid overturn structure, the user can rotate the display panel 1 relative to the base member 2 to have the display screen 13 of the display panel 1 face the keyboard 231 of the base member 2, enabling the dual-usage computer 4 to be used as a notebook computer as shown in FIG. 1.

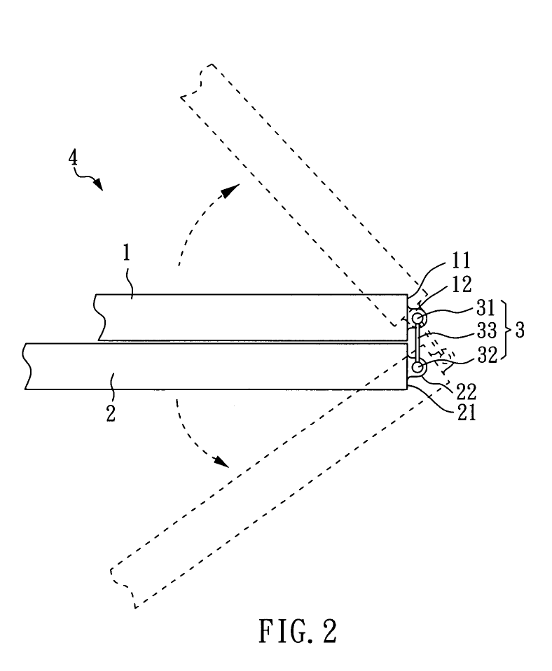

When wishing to use the dual-usage computer 4 as a tablet PC, rotate the display panel 1 outwards from the base member 2 to have the back side of the display panel 1 be attached to the bottom side of the base member 2 (see FIG. 2). At this time, the user can use a touch pen 14 to touch the display screen 13, performing an input action as shown in FIG. 3.

As indicated above, by means of the overturn structure, the user can conveniently rotate the display panel 1 relative to the base member 2 to set the dual-usage computer 4 alternatively between the notebook computer mode and the tablet PC mode.

According to the aforesaid preferred embodiment of the present invention, the first and second pivot elements 12 and 22 are knuckles (pivot holes) and respectively provided at the display panel 1 and the base member 2 and the first and second coupling elements 31 and 32 of the coupling devices 3 are pivot pins. Alternatively, pivot pins can be respectively provided at the display panel 1 and the base member 2, and the first and second coupling elements 31 and 32 of the coupling devices 3 can be knuckles (pivot holes) respectively coupled to the pivot pins at the display panel 1 and the base member 2.

Although the present invention has been explained in relation to its preferred embodiment, it is to be understood that many other possible modifications and variations can be made without departing from the spirit and scope of the invention as hereinafter claimed.

What is claimed is:

1. An overturn structure used in a dual-usage computer comprising a display panel and a base member carrying a keyboard for enabling said display panel and said base member to be rotated relative to each other and alternatively set between a first mode to have the dual-usage computer be used as a notebook computer and a second mode to have the dual-usage computer be used as a tablet PC, the overturn structure comprising:
at least one first pivot element respectively fixedly provided at a lateral side of said display panel;
at least one second pivot element respectively fixedly provided at a lateral side of said base member corresponding to said at least one first pivot element; and
at least one coupling device respectively coupled between said at least one first pivot element and said at least one second pivot element to join said display panel and said base member, said at least one coupling device having a first coupling element pivoted to said at least one first pivot element, a second coupling element pivoted to said at least one second pivot element, and a connecting member connected between one end of said first coupling element and one end of said second coupling element to hold said first coupling element and said second coupling element in parallel.

2. The overturn structure as claimed in claim 1, wherein said at least one first pivot element is a knuckle; the first coupling element of said at least one coupling device is a pivot pin.

3. The overturn structure as claimed in claim 1, wherein said at least one second pivot element is a knuckle; the second coupling element of said at least one coupling device is a pivot pin.

4. The overturn structure as claimed in claim 1, wherein said display panel is a touch panel display device for use with a touch pen for input.
